(19) United States
(12) Patent Application Publication
(10) Pub. No.: US 2025/0380104 A1
(43) Pub. Date: Dec. 11, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Kazuhiko FUKUTANI, Kanagawa (JP); Ryuichi NANAUMI, Tokyo (JP)

(21) Appl. No.: 19/225,112

(22) Filed: Jun. 2, 2025

(30) Foreign Application Priority Data
Jun. 5, 2024 (JP) 2024-091598

(51) Int. Cl. H04S 7/00; H04N 21/43

(52) U.S. Cl. CPC H04S 7/302; H04N 21/4307; H04S 2400/11

(57) ABSTRACT

An information processing apparatus comprising: a memory storing instructions, and at least one processor configured to execute the instructions to: perform time synchronization processing for a plurality of video signals obtained by capturing a subject by a plurality of cameras in a space and a plurality of acoustic signals collected by a plurality of microphones in the space; calculate position information of the subject using the plurality of video signals and imaging conditions of the plurality of cameras; separate a sound source signal of the subject from the plurality of acoustic signals having undergone the synchronous processing; and generate an acoustic signal for listening, at an arbitrary listening position in the space, the sound source signal generated from the subject, by assigning the sound source signal of the subject to a position corresponding to the position information of the subject.

### BACKGROUND

### Field of the Technology

The present disclosure relates to an information processing apparatus, an information processing method, and a non-transitory computer-readable storage medium.

### Description of the Related Art

There are known free-viewpoint image generation technologies capable of generating a video from a free position and angle in a space, that is, video content (free-viewpoint video) captured from the viewpoint (virtual viewpoint) of a virtual camera by reconstructing three-dimensional space data of a subject such as a person or an object from a captured image (Masayuki Tanimoto and Toshiaki Fujii, “Free-viewpoint Image Generation Technologies”, The journal of the Institute of Image Information and Television Engineers, Vol. 60, No. 1, pp. 29-34 (2006)).

Japanese Patent Laid-Open No. 2019-033497 discloses a system for generating an acoustic signal according to an image at a virtual viewpoint and a change in viewpoint using video signals and acoustic signals obtained at the same time.

However, in the technique described in Japanese Patent Laid-Open No. 2019-033497, it is possible to express a change in sound according to a change in viewpoint but it is difficult to generate, as an expression of a more realistic sound, an acoustic signal for listening, at an arbitrary listening position in a space, a sound source signal generated from a sound source.

### SUMMARY

In consideration of the above-described problem, the present disclosure provides a technique of generating an acoustic signal for listening, at an arbitrary listening position in a space, a sound source signal generated from a sound source.

According to one aspect of the present disclosure, there is provided an information processing apparatus comprising: a memory storing instructions, and at least one processor configured to execute the instructions to: perform time synchronization processing for a plurality of video signals obtained by capturing a subject by a plurality of cameras in a space and a plurality of acoustic signals collected by a plurality of microphones in the space; calculate position information of the subject using the plurality of video signals and imaging conditions of the plurality of cameras; separate a sound source signal of the subject from the plurality of acoustic signals having undergone the synchronous processing; and generate an acoustic signal for listening, at an arbitrary listening position in the space, the sound source signal generated from the subject, by assigning the sound source signal of the subject to a position corresponding to the position information of the subject.

According to another aspect of the present disclosure, there is provided an information processing method comprising: performing time synchronization processing for a plurality of video signals obtained by capturing a subject by a plurality of cameras in a space and a plurality of acoustic signals collected by a plurality of microphones in the space; calculating position information of the subject using the plurality of video signals and imaging conditions of the plurality of cameras; separating a sound source signal of the subject from the plurality of acoustic signals having undergone the synchronous processing; and generating an acoustic signal for listening, at an arbitrary listening position in the space, the sound source signal generated from the subject, by assigning the sound source signal of the subject to a position corresponding to the position information of the subject.

Further features of the present disclosure will become apparent from the following description of exemplary embodiments (with reference to the attached drawings).

### BRIEF DESCRIPTION OF THE DRAWINGS

FIG. 1 is a view showing an example of the configuration of an information processing apparatus according to the first embodiment;

FIG. 2 is view showing an example of the configuration of a video signal processing unit of the information processing apparatus according to the first embodiment;

FIG. 3 is a view showing examples of a three-dimensional model of a subject and three-dimensional coordinate information of a reference point according to the first embodiment;

FIG. 4 is a flowchart illustrating the procedure of processing in the information processing apparatus according to the first embodiment;

FIG. 5 is a view showing an example of the configuration of an information processing apparatus according to the second embodiment;

FIG. 6 is a view showing examples of a three-dimensional model of a subject and three-dimensional coordinate information of a reference point according to the second embodiment;

FIG. 7 shows timing charts showing an example of the effect of sound source separation by a beamforming method;

FIG. 8 is a flowchart illustrating the procedure of processing in the information processing apparatus according to the second embodiment;

FIG. 9 is a view showing the effect of the third embodiment; and

FIG. 10 shows timing charts showing an example of the effect of the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Example of Configuration of Information Processing Apparatus 100)

In the first embodiment, coordinate data, on a three-dimensional space, of an arbitrary reference point of each subject is calculated from video signals obtained by a plurality of imaging units, and a sound (sound source signal) generated by each subject is separated based on acoustic signals obtained by a plurality of sound collection units, thereby generating a sound source signal of each subject. Note that in a case where a plurality of subjects are obtained from video signals, a sound is not always assigned to each of all the obtained subjects, a sound source signal is assigned to a subject that generates a sound, and no sound is assigned to a subject that generates no sound. The reference point of each subject indicates position information of each subject to which the generated sound source signal is assigned. The position information is determined based on three-dimensional coordinate data. By obtaining three-dimensional position information (three-dimensional coordinate data) of the reference point of the subject from the video signals, it is possible to assign the sound source signal to the correct position information of the subject in the three-dimensional space. By performing acoustic processing in consideration of the direction and distance of the subject, the presence of an obstacle, and the like when viewed from an arbitrary listening position (virtual listening point) in the three-dimensional space, it is possible to generate acoustic content (free-listening point acoustic signal) in which a sound generated from the position (sound source) of the reference point can be listened as a more realistic sound at an arbitrary listening position (virtual listening point) in the three-dimensional space.

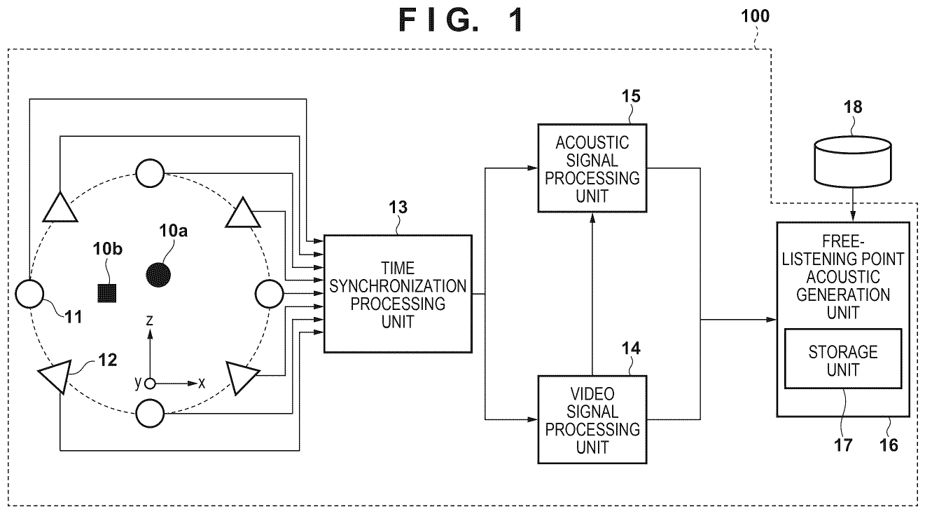

FIG. 1 is a schematic view showing an example of the configuration of the information processing apparatus 100 according to this embodiment. The information processing apparatus 100 includes a plurality of imaging units 11, a plurality of sound collection units 12, a time synchronization processing unit 13, a video signal processing unit 14, an acoustic signal processing unit 15, and a free-listening point acoustic generation unit 16. The free-listening point acoustic generation unit 16 may include, as an internal memory, a storage unit 17 that stores various kinds of information. The storage unit 17 can be implemented by a memory card including a flash memory, or a nonvolatile recording device such as a Solid State Drive (SSD) or a Hard Disk Drive (HDD).

The free-listening point acoustic generation unit 16 may be connected to a database 18 of an external server, which is not a component of the information processing apparatus 100, via a network, and obtain various kinds of information stored in the database 18. The free-listening point acoustic generation unit 16 may store, in the storage unit 17, the various kinds of information obtained from the database 18 of the external server, thereby updating the various kinds of information.

The various kinds of information may include a head-related transfer function to be used for processing of generating acoustic content (free-listening point acoustic signal). A head-related transfer function obtained in advance in the three-dimensional space may be stored in the storage unit 17 or the database 18. The free-listening point acoustic generation unit 16 may generate acoustic content (free-listening point acoustic signal) using the various kinds of information stored in the database 18 or the storage unit 17. Alternatively, the free-listening point acoustic generation unit 16 may interpolate the information obtained from the storage unit 17 or the database 18 based on the relative positional relationship between the listening position and the position of the position information (three-dimensional coordinate information) of the reference point, and then use the information.

The time synchronization processing unit 13, the video signal processing unit 14, the acoustic signal processing unit 15, and the free-listening point acoustic generation unit 16 can be formed by a workstation, a personal computer, a tablet PC, a smartphone, a server, a Field Programmable Gate Array (FPGA), an Application Specific Integrated Circuit (ASIC), a microcomputer, or the like.

FIG. 1 shows a subject 10 (10a and 10b) although they are not components of the information processing apparatus 100. The subject 10 may be any subject that generates a sound, such as a person, animal, or musical instrument. The number of subjects 10 may be one or plural.

Each of the plurality of imaging units 11 is typically a camera, but may be any device that can obtain a video signal of the subject 10. The imaging unit 11 captures a moving image and/or a still image. The number of imaging units 11 need only be at least two in order to correctly obtain the three-dimensional position information of the subject based on obtained video signals. Note that as the imaging unit 11, a depth camera that can obtain depth information may be used. The imaging units 11 are preferably arranged on the periphery of the subject 10 to surround it, as shown in FIG. 1. This can more correctly obtain the position information of the subject 10 in the three-dimensional space of the subject 10. However, if the installation space of the imaging units 11 is limited, the imaging units 11 may be arranged to surround a part of the periphery of the subject 10.

Assume that imaging conditions such as the position, the depression angle, the direction, the angle of view, and the focal length of each imaging unit 11 are obtained in advance by preliminary calibration. Note that if the imaging unit 11 is a camera, the camera position is three-dimensional coordinate data indicating the camera position in the imaging space. The camera depression angle is a depression angle at which the viewpoint faces, and is designated within the range of +90° when the horizontal direction is set as 0°. The camera direction is the direction of a horizontal plane in which the camera faces. In this embodiment, by setting, as a reference front direction, the absolute direction obtained by setting the due north (that is, the positive direction of the Y-axis) as 0°, the right-handed (clockwise) direction indicates the positive direction and the left-handed (counterclockwise) direction indicates the negative direction. The angle of view is a value representing the width of the captured video by an angle. The focal length is a value representing the distance from the optical center of a camera lens to an imaging plane.

Each of the plurality of sound collection units 12 is typically a microphone, but may be any device that can collect a sound generated by the subject 10. The sound collection unit 12 receives a sound generated by the subject 10, and converts it into an electrical acoustic signal. The sound collection unit 12 may be an omnidirectional unit that can receive sounds from all directions, or a directional unit that has sensitivity in a specific direction. Note that the sound collection unit 12 may be incorporated in the imaging unit 11 or may be externally connected. The number of sound collection units 12 is preferably at least equal to or larger than the number of separated sound sources.

For example, if the number of subjects each of which generates a sound is three and a background sound is also separated, the number of sound collection units 12 is preferably four or more. Note that as the number of sound collection units 12 is larger, it is possible to more correctly separate the sound source signal of each subject from the acoustic signals. The plurality of sound collection units 12 are preferably arranged on the periphery of the subject 10 to surround it. This can correctly separate the sound source signal of each subject 10. However, if the installation space of the sound collection units 12 is limited, the sound collection units 12 may be arranged to surround a part of the periphery of the subject 10. Note that sound collection conditions such as the position, the depression angle, and the direction of each sound collection unit 12 are known by preliminary calibration or the like.

If the space coordinate system obtained by calibration is different between the imaging unit 11 and the sound collection unit 12, the space coordinate systems of the imaging unit 11 and the sound collection unit 12 are matched by obtaining a transformation matrix for matching one space coordinate system with the other by known cross-calibration.

The time synchronization processing unit 13 makes the timing of obtaining the video signal obtained by each imaging unit 11 coincide with the timing of obtaining the acoustic signal obtained by each sound collection unit 12 on the time base. The timing at which each video signal is obtained and at which each acoustic signal is obtained are made coincide with each other on the time base by obtaining, in advance, the time shift of each signal by calibration, and performing correction processing by the time synchronization processing unit 13.

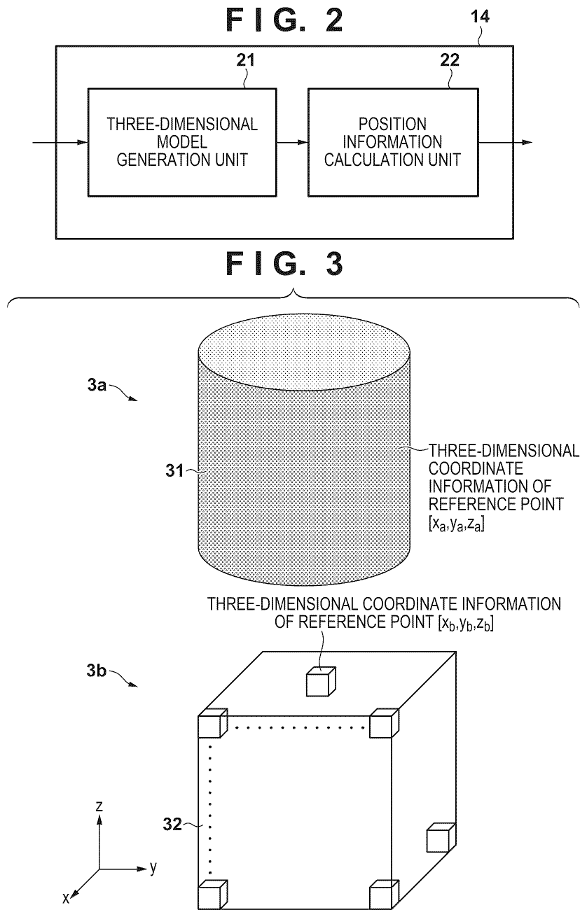

The video signal processing unit 14 calculates the position information (three-dimensional coordinate information) of each subject 10 in the three-dimensional space using the plurality of video signals having undergone the time synchronization processing and the imaging conditions such as the position, the depression angle, the direction, the angle of view, and the focal length of each imaging unit 11 obtained in advance by calibration or the like. FIG. 2 is a view showing an example of the configuration of the video signal processing unit 14 in the information processing apparatus 100 according to this embodiment. As shown in FIG. 2, the video signal processing unit 14 includes a three-dimensional model generation unit 21 that generates a three-dimensional shape model of the subject 10, and a position information calculation unit 22 that calculates the position information of the subject 10 in the three-dimensional space.

The three-dimensional model generation unit 21 generates three-dimensional model data (three-dimensional shape data) of the subject 10 based on the plurality of video signals having undergone the time synchronization processing. For example, the three-dimensional model generation unit 21 generates three-dimensional model data of the subject 10 from a plurality of two-dimensional images using shape-from-silhouette or a stereo method. In this embodiment, generation of three-dimensional model data of the subject 10 is also be referred to as reconstruction. A method of generating three-dimensional model data by shape-from-silhouette or a stereo method is known and a description thereof will be omitted. The three-dimensional model data is typically point cloud data or mesh data but may be in any data format as long as it is possible to express the three-dimensional shape of the subject 10.

The position information calculation unit 22 calculates the coordinates of an arbitrary reference point of each subject in the three-dimensional space using the three-dimensional model data of each subject generated by the three-dimensional model generation unit 21. The reference point indicates the position of the sound source of a sound generated from each subject, and can be calculated as arbitrary three-dimensional coordinate information in the three-dimensional model data of each subject. FIG. 3 is a view showing an example of the three-dimensional model data of the subject and the three-dimensional coordinate information of the reference point according to this embodiment. The three-dimensional model data of the subject and the space coordinates of the reference point of the subject will be described in detail below with reference to FIG. 3.

In FIG. 3, reference numeral 3a denotes a view showing an example of the point cloud data of the subject 10a. Point cloud data 31 is a set of color information (R, G, B) and three-dimensional coordinate information (x, y, z), on an orthogonal coordinate system, of an observation point on or in the object shape in the three-dimensional space. The center point, the maximum point, the minimum point, and the like can readily be calculated from the range of the three-dimensional coordinate information. FIG. 3 shows an example in which the center point obtained from the center of the x-coordinate, the center of the y-coordinate, and the center of the z-coordinate of the three-dimensional coordinate information is set as the reference point of the subject 10a. In reference numeral 3a in FIG. 3, the three-dimensional coordinate information of the reference point of the subject 10a is represented by [xₐ, yₐ, zₐ].

In FIG. 3, reference numeral 3b denotes a view showing an example of voxel mesh data 32 of the subject 10b. Similar to the point cloud data in reference numeral 3a in FIG. 3, since the three-dimensional coordinate information (x, y, z) and the color information (R, G, B) are assigned to each voxel, the center point, the maximum point, the minimum point, and the like of the subject 10b can readily be calculated from the range of the three-dimensional coordinate information. FIG. 3 shows an example in which the maximum point of the z-coordinate of the three-dimensional coordinate information is set as the reference point of the subject 10b. In reference numeral 3b in FIG. 3, the three-dimensional coordinate information of the reference point of the subject 10b is represented by [x_{b}, y_{b}, z_{b}].

Note that if the subject is a person/animal, and the position of the head or mouth can be recognized, an arbitrary point of the head or mouth may be set as the reference point, thereby obtaining three-dimensional coordinate information. The subject may include a plurality of sound sources, and a plurality of reference points may be set for the subject. Furthermore, if a plurality of reference points are within a predetermined distance, a region (three-dimensional coordinate region) including the plurality of reference points may be set as the position information of a reference region in the subject. If there exist a plurality of subjects, the same processing is performed for each subject, thereby calculating the three-dimensional coordinate information of the reference point of each subject. Note that any processing may be used as long as it is possible to calculate the three-dimensional coordinate information of an arbitrary reference point of the subject based on the plurality of video signals. By using the video signals as described above, the position information (three-dimensional coordinate information) of the reference point of the subject that can be a sound source can accurately be obtained in the three-dimensional space.

The acoustic signal processing unit 15 separates a sound (sound source signal) generated by each subject using the plurality of acoustic signals having undergone the time synchronization processing. Typically, by a blind source separation method such as independent component analysis, the acoustic signal processing unit 15 separates sound sources the number of which is equal to the number of subjects, or sound sources the number of which is equal to the number of subjects and a background sound. The blind source separation method such as independent component analysis is a method of separating the sound source signal of each subject in the space based on differences in characteristics of the sound source signals that the sound sources are statistically independent of each other, without requiring prior knowledge of the arrangement of the microphones and the incoming direction of the subject sound. By using the blind source separation method, it is possible to execute sound source separation without being affected by the motion or movement of the subject. Note that any method may be used as long as it is possible to separate the sound source signal of each subject without using the position information of the subject as a sound source, that is, the information of the space model such as the incoming direction of the sound. For example, by using a neural network represented by deep learning, a sound (sound source signal) generated from each subject may be separated from the plurality of acoustic signals collected by the plurality of sound collection units 12.

The free-listening point acoustic generation unit 16 assigns the sound source signal of each subject to the position information (three-dimensional coordinate information) of the reference point of each subject, and performs acoustic processing in consideration of the direction and distance of the subject, the presence of an obstacle, and the like when viewed from an arbitrary listening position (virtual listening point) in the three-dimensional space. The free-listening point acoustic generation unit 16 assigns the sound source signal of the subject to the position information of the reference point, and generates an acoustic signal (free-listening point acoustic signal) for listening, at an arbitrary listening position in the space, a sound source signal generated from the reference point. More specifically, the free-listening point acoustic generation unit 16 performs a convolution operation as a mathematical processing to incorporate the position information (three-dimensional coordinate information) of the reference point of the subject and the head-related transfer function at the virtual listening point in the sound source signal of each subject. The head-related transfer function is a function representing the transfer characteristic of a sound from the position information (three-dimensional coordinate information) of the reference point of each subject to the virtual listening point, that is, a function representing how the sound (sound source signal) generated at the position of the reference point of each subject changes until it reaches the virtual listening point. The head-related transfer function represents how the sound (sound source signal) generated at the position of the reference point of each subject sounds at the position of the virtual listening point, and can change depending on the relative positional relationship (distance and angle) between the position of the reference point of each subject (the position of the sound source of the sound generated by the subject) and the position of the virtual listening point.

With respect to the head-related transfer function, data of a plurality of head-related transfer functions obtained in advance by changing the relative distance and angle between the position of the sound source and the position of the virtual listening point in the three-dimensional space are stored in advance. The data of the plurality of head-related transfer functions may be stored in the storage unit 17 in the free-listening point acoustic generation unit 16 or stored in the database 18 of the external server.

By using the head-related transfer function stored in the storage unit 17 or the database 18, the free-listening point acoustic generation unit 16 performs a convolution operation that incorporates, in the sound source signal of each subject, the head-related transfer function set based on the relative positional relationship between the position information of the reference point of the subject and the virtual listening point. The sound source signal thus generated by the free-listening point acoustic generation unit 16 is called a free-listening point acoustic signal (free-listening point acoustic content). Note that the head-related transfer function stored in advance may be interpolated based on the relative positional relationship (distance and angle) between the position information of the reference point of the subject and the position of the virtual listening point. For example, if the position information of the reference point or the position of the virtual listening point moves (changes) in the three-dimensional space, the head-related transfer function is interpolated based on the distance and angle, and the sound source signal (free-listening point acoustic signal) of each subject is generated using the interpolated head-related transfer function.

In accordance with the type of a reproduction apparatus that reproduces the free-listening point acoustic signal, the free-listening point acoustic generation unit 16 may change a signal to be output. The free-listening point acoustic generation unit 16 may determine the type of a reproduction apparatus by communicating with the reproduction apparatus that can reproduce a sound, and change, in accordance with the result of the determination, a signal to be output. Communication with the reproduction apparatus may be wired communication or wireless communication.

If the reproduction apparatus can reproduce a sound at the listening position, the free-listening point acoustic generation unit 16 outputs the generated acoustic signal. If, for example, a sound (sound source signal) is reproduced by a headphone, the free-listening point acoustic generation unit 16 outputs the generated free-listening point acoustic signal of the subject. By outputting the free-listening point acoustic signal, the headphone can perform binaural reproduction.

If the reproduction apparatus is an apparatus that reproduces a sound at a position different from the listening position, the free-listening point acoustic generation unit 16 outputs the calculated position information of the reference point of the subject and the separated sound source signal of the subject. If, for example, a sound field is reproduced by a loudspeaker, the free-listening point acoustic generation unit 16 outputs, using an object-based audio technique, the position information (three-dimensional coordinate information) of the reference point of each subject and the separated sound source signal of each subject to an object audio renderer (for example, a reproduction-side signal processing apparatus) included in the reproduction-side apparatus.

The reproduction-side signal processing apparatus successively compares the position information (three-dimensional coordinate information) of the reference point of each subject, the separated sound source signal of each subject, and the position information (three-dimensional coordinate information) of the loudspeaker, and calculates a sound to be reproduced from a specific loudspeaker.

### (Processing Procedure)

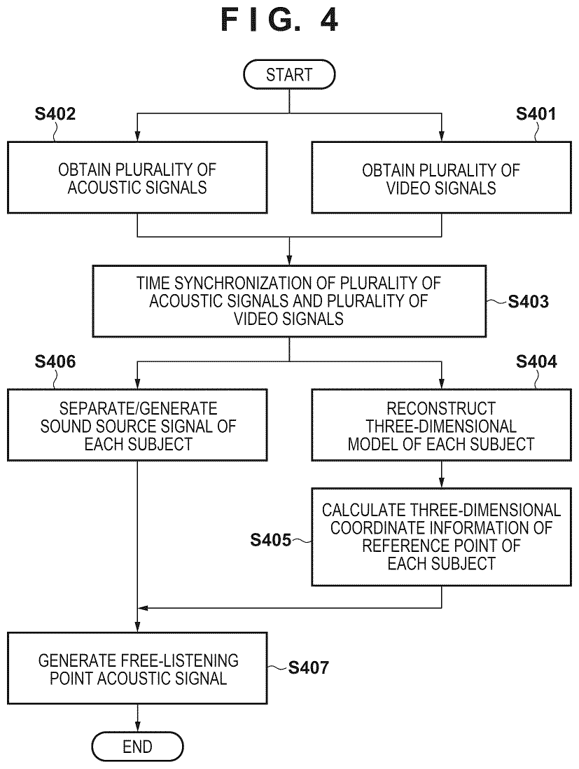

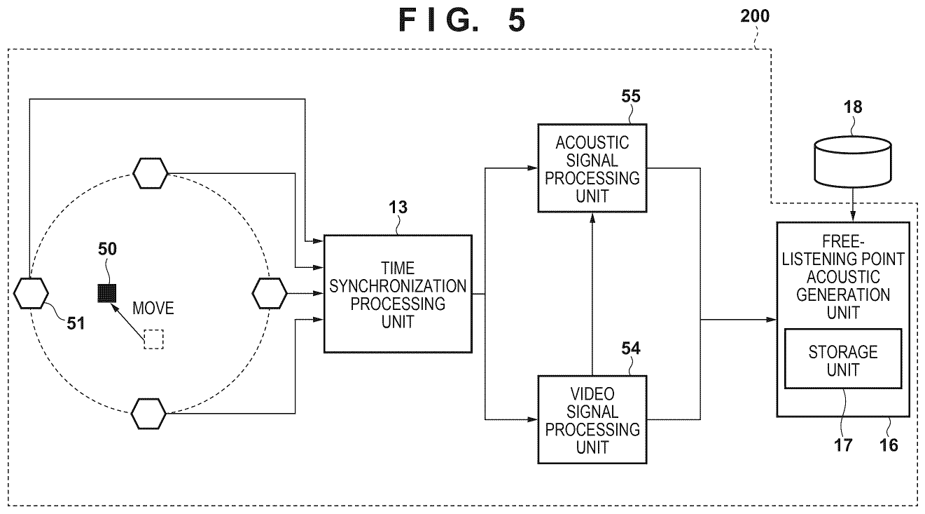

FIG. 4 is a flowchart illustrating an example of the procedure of processing in the information processing apparatus 100 according to the first embodiment. The processing of the information processing apparatus 100 according to the first embodiment will be described with reference to FIG. 4. In a description of FIG. 4, a symbol “S” means a step.

In S401, the plurality of imaging units 11 obtain a plurality of video signals. Next, in S402, the plurality of sound collection units 12 obtain a plurality of acoustic signals.

Next, in S403, the time synchronization processing unit 13 adjusts the timings of the plurality of video signals and the plurality of acoustic signals on the time base, thereby obtaining the signals synchronized on the time base.

In S404, the three-dimensional model generation unit 21 of the video signal processing unit 14 generates three-dimensional model data (three-dimensional shape data) of each subject using the plurality of video signals having undergone the time synchronization processing and the imaging conditions. The three-dimensional model generation unit 21 generates, for example, point cloud data or mesh data as the three-dimensional model data of each subject. The imaging conditions can include the position, the depression angle, the direction, the angle of view, and the focal length of each imaging unit 11.

In S405, the position information calculation unit 22 of the video signal processing unit 14 calculates position information (three-dimensional coordinate information) of an arbitrary point (reference point) from the three-dimensional model data of each subject.

Next, in S406, by a sound source separation technique (for example, the blind source separation method or the like) based on the plurality of acoustic signals having undergone the time synchronization processing and differences in characteristics of the sound source signals generated by the subjects in the three-dimensional space, the acoustic signal processing unit 15 separates the sound (sound source signal) generated by the subject from the plurality of acoustic signals having undergone the time synchronization processing, thereby generating the sound source signal of the subject. The differences in characteristics of the sound source signals can include, for example, differences in tones of the sound source signals and statistical properties. Note that if a plurality of subjects are obtained from the video signals, a sound is not always assigned to each of all the obtained subjects, a sound source signal is assigned to a subject that generates a sound, and no sound is assigned to a subject that generates no sound.

Finally, in S407, the free-listening point acoustic generation unit 16 generates a free-listening point acoustic signal by incorporating, in the sound source signal of each subject, the head-related transfer function set based on the relative positional relationship between the position information (three-dimensional coordinate information) of the reference point and the virtual listening point. According to this embodiment, it is possible to generate an acoustic signal (free-listening point acoustic signal) for listening, at an arbitrary listening position in the space, the sound source signal generated from the sound source. Since it is possible to assign the sound source signal to the accurately obtained position information (three-dimensional coordinate information) of the reference point of the subject, it is possible to generate a more realistic free-listening point acoustic signal.

### Second Embodiment

### (Example of Configuration of Information Processing Apparatus 200)

In the second embodiment, time-series position information (locus data), in the three-dimensional space, of the reference point of at least one subject is calculated from a plurality of video signals (moving images) obtained by a plurality of imaging units 11. By using the time-series position information (locus data) in the three-dimensional space and a plurality of acoustic signals obtained by a plurality of imaging/sound collection units 51, a sound (sound source signal) generated from each subject is separated by a sound source separation technique based on space data, thereby generating the sound source signal of each subject.

By using, for sound source separation, the time-series position information (locus data) of the reference point of the subject obtained from the plurality of video signals (moving images) obtained by the plurality of imaging/sound collection units 51, it is possible to correctly obtain the position information (three-dimensional coordinate information) of the subject in the three-dimensional space, and generate the sound source signal of each subject more accurately. This can generate a more realistic free-listening point acoustic signal.

FIG. 5 is a schematic view showing an example of the configuration of the information processing apparatus 200 according to this embodiment. The information processing apparatus 200 includes the imaging/sound collection units 51 each formed by integrating the imaging unit 11 and the sound collection unit 12, a time synchronization processing unit 13, a video signal processing unit 54, an acoustic signal processing unit 55, and a free-listening point acoustic generation unit 16. The time synchronization processing unit 13, the video signal processing unit 54, the acoustic signal processing unit 55, and the free-listening point acoustic generation unit 16 can be formed by a workstation, a personal computer, a tablet PC, a smartphone, a server, a Field Programmable Gate Array (FPGA), an Application Specific Integrated Circuit (ASIC), a microcomputer, or the like. FIG. 5 shows a subject 50 as an imaging target although it is not a component of the information processing apparatus 200, and the subject 50 moves in the three-dimensional space.

Each imaging/sound collection unit 51 may typically be formed by a camera incorporating a microphone or externally connected to a microphone. When the camera and the microphone are directly connected in this way, each imaging/sound collection unit 51 readily performs time synchronization processing of the video signal and the acoustic signal. The number of imaging/sound collection units 51 need only be at least two. Note that the plurality of imaging/sound collection units 51 are arranged on the periphery of the subject 50 to surround it, and imaging and sound collection conditions such as the position, the depression angle, and the direction of each imaging/sound collection unit 51 are obtained in advance by a known calibration method.

The time synchronization processing unit 13 and the free-listening point acoustic generation unit 16 can perform the same processing as described in the first embodiment. The video signal processing unit 54 includes a three-dimensional model generation unit and a position information calculation unit, similar to FIG. 2 in the first embodiment.

The three-dimensional model generation unit of the video signal processing unit 54 calculates time-series position information (locus data) of the subject 50 in the three-dimensional space based on the plurality of video signals (moving images) having undergone the time synchronization processing and the imaging conditions such as the position, the depression angle, the direction, the angle of view, and the focal length of each imaging/sound collection unit 51. For example, the three-dimensional model generation unit generates (reconstructs) three-dimensional model data of the subject from a plurality of frame images (two-dimensional images) at a given time using shape-from-silhouette or a stereo method. By repeating this processing for the necessary number of frames, the three-dimensional model generation unit can generate (reconstruct) three-dimensional model data of the subject at each time.

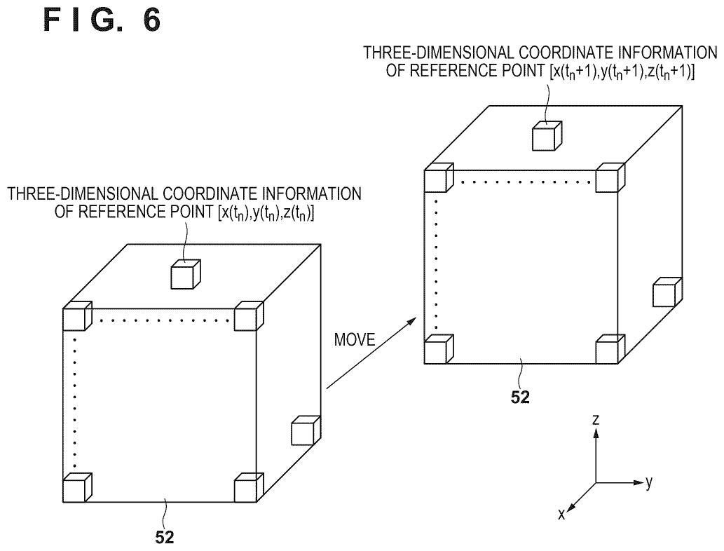

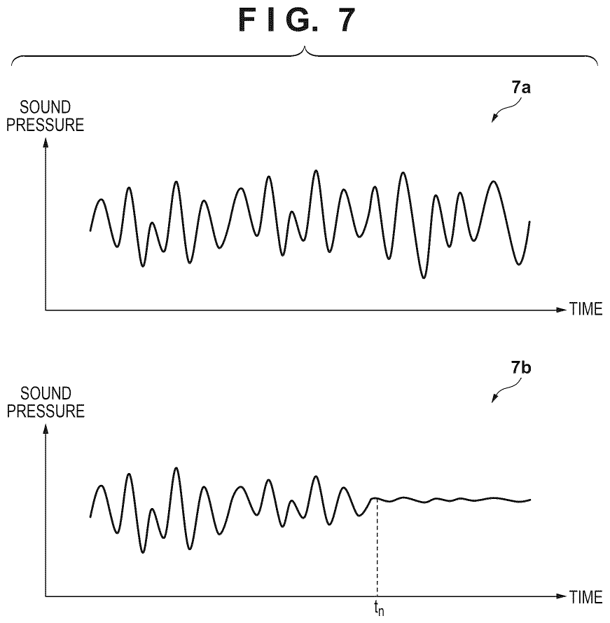

Similar to the first embodiment, the position information calculation unit of the video signal processing unit 54 calculates time-series position information (locus data) of the reference point of each subject in the three-dimensional space from the three-dimensional model data of each subject at each time. The three-dimensional model data of the subject and the time-series position information (locus data) of the reference point of the subject 50 will be described in detail with reference to FIG. 6.

FIG. 6 is a view showing an example of voxel mesh data 52 of the subject 50. FIG. 6 shows an example in which the maximum point of the z-coordinate of the three-dimensional coordinate information is set as the reference point of the subject 50. The position information (three-dimensional coordinate information) of the reference point at time tₙ is represented by [x(tₙ), y(tₙ), z(tₙ)]. As shown in FIG. 6, along with the motion or movement of the subject 50, the position information (three-dimensional coordinate information) of the reference point also moves. The position information (three-dimensional coordinate information) of the reference point at time tₙ₊₁, to which the subject 50 moves from the position at time tₙ, is represented by [x(tₙ+1), y(tₙ+1), z(tₙ+1)]. As shown in FIG. 6, along with the movement of the subject 50, the three-dimensional coordinate information of the reference point of the subject 50 also changes. A position information calculation unit calculates locus data of the time-series position information (three-dimensional coordinate information) of the reference point of the subject 50. If the subject 50 moves in the three-dimensional space, the position (position information) of the locus data can be the position (position information) of the reference point.

The acoustic signal processing unit 55 separates a sound (sound source signal) generated by each subject from the plurality of acoustic signals using the locus data representing the time-series position information (three-dimensional coordinate information) of the reference point of each subject generated by the video signal processing unit 54, the plurality of acoustic signals having undergone the time synchronization processing, and the sound collection conditions of each imaging/sound collection unit 51. The sound collection conditions can include the position, the depression angle, the direction, and the directivity of each imaging/sound collection unit 51.

The acoustic signal processing unit 55 can separate the sound source signal for each subject using a beamforming method. For example, in Delay-and-Sum (DAS) beamforming as one beamforming method, it is possible to obtain a sound source signal that focuses on a sound generated at the position of the three-dimensional coordinate information of the reference point of the subject by adjusting a time delay to match the phases of the plurality of collected acoustic signals in accordance with a distance obtained based on the position information (three-dimensional coordinate information) of the reference point of the subject and the position information of each imaging/sound collection unit 51.

In Minimum Variance Distortionless Response (MVDR) beamforming as one adaptive beamforming method, it is possible to obtain a sound generated at the position of the three-dimensional coordinate information of the reference point of the subject more preferentially than in Delay-and-Sum (DAS) beamforming by adaptively decreasing the phases and amplitudes of the collected acoustic signals so as to minimize sounds other than the sound generated at the position of the position information (three-dimensional coordinate information) of the reference point of the subject.

In the beamforming method, even if the three-dimensional coordinate information of the reference point of the subject changes, it is possible to obtain a sound source signal that focuses on the position information (three-dimensional coordinate information) of the reference point of the subject that always moves by changing a time delay based on the change in three-dimensional coordinate information. As the change in three-dimensional coordinate information of the reference point of the subject, for example, the delay time is set shorter than a predetermined reference delay time in a case where the subject approaches the imaging/sound collection unit 51. Alternatively, in a case where the subject moves away from the imaging/sound collection unit 51, the delay time is set longer than the predetermined reference delay time. Since this beamforming method is based on the position information (three-dimensional coordinate information) of the reference point of the subject, it can reduce a calculation load and is superior in real-time property, as compared with a blind source separation method such as independent component analysis.

FIG. 7 shows timing charts showing an example of the effect of sound source separation by the beamforming method. In FIG. 7, the abscissa represents the time and the ordinate represents a sound pressure (sound volume). In FIG. 7, reference numeral 7a denotes a view showing an example in which the time delay of each acoustic signal is adjusted in accordance with the time-series position information (locus data) of the reference point of the subject, and the sound source signal of the subject is obtained. In reference numeral 7a in FIG. 7, an example in which a constant sound is always generated from a moving subject is shown. Even if the subject moves as shown in reference numeral 7a in FIG. 7, it is possible to obtain the sound source signal of substantially the same sound pressure (sound volume).

In FIG. 7, reference numeral 7b denotes a view showing an example in which the time delay of each acoustic signal is adjusted by focusing on the position information (three-dimensional coordinate information) of the reference point of the subject at given time tₙ, and the sound source signal of the subject is obtained. As shown in reference numeral 7b in FIG. 7, if the delay time of each generated acoustic signal is adjusted by focusing on the three-dimensional coordinate information of the reference point of the subject at given time tₙ, the sound source signal of the subject becomes small in accordance with the movement of the subject. By adjusting the time delay to match the phases of the plurality of collected acoustic signals in accordance with the distance obtained based on the position information of the reference point of the subject and the position information of each imaging/sound collection unit 51, it is possible to obtain the sound source signal that focuses on the sound generated at the position of the three-dimensional coordinate information of the reference point of the subject. That is, in consideration of the relative positional relationship between each imaging/sound collection unit 51 and the subject, the sound source signal of each subject can correctly be obtained. In reference numeral 7b in FIG. 7, a method of learning the sound source signal of each subject by sound source separation using the beamforming method is shown, but any method of performing sound source separation based on the spatial positional relationship between each imaging/sound collection unit 51 and the three-dimensional coordinate information of the reference point of the subject calculated by the video signal processing unit 54, that is, the space model may be used. For example, the sound source signal of each subject may be separated by deep learning using input data based on the acoustic signals having undergone delay processing in accordance with the spatial positional relationship between the subject and each imaging/sound collection unit 51.

The free-listening point acoustic generation unit 16 generates a free-listening point acoustic signal by the same method as in the first embodiment using the local data of the time-series position information (three-dimensional coordinate information), in the three-dimensional space, of the reference point of each subject generated by the video signal processing unit 54, and the sound source signal of each subject generated by the acoustic signal processing unit 55. That is, the free-listening point acoustic generation unit 16 assigns the sound source signal of each subject to the time-series position information (three-dimensional coordinate information) of the reference point of each subject, which changes along with movement, and performs acoustic processing in consideration of the direction and distance of the subject, the presence of an obstacle, and the like when viewed from an arbitrary listening position (virtual listening point) in the three-dimensional space. If the subject 50 moves in the three-dimensional space, the free-listening point acoustic generation unit 16 assigns the sound source signal of the subject to the position of the locus data as the position of the reference point, and generates an acoustic signal (free-listening point acoustic signal) for listening, at an arbitrary listening position in the space, a sound source signal generated from the position of the locus data. With the processing of the information processing apparatus 200, even if the subject 50 moves, it is possible to generate a more realistic free-listening point acoustic signal.

### (Processing Procedure)

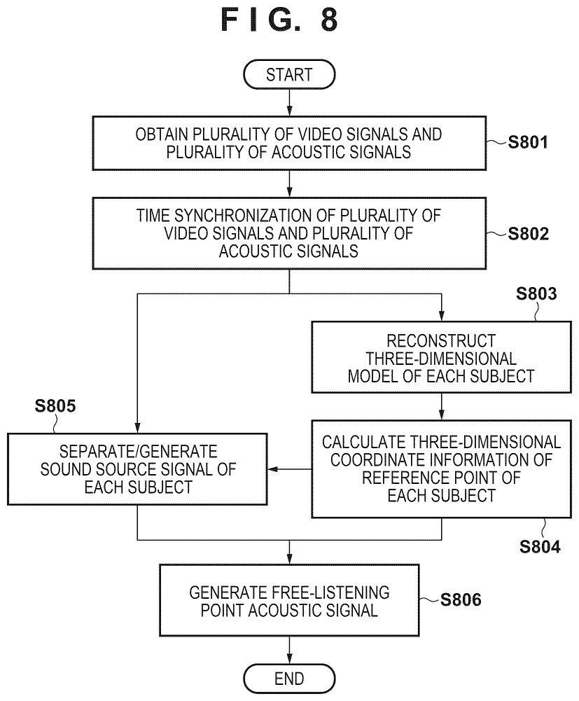

FIG. 8 is a flowchart illustrating an example of the procedure of processing in the information processing apparatus 200 according to the second embodiment. The processing of the information processing apparatus 200 according to the second embodiment will be described with reference to FIG. 8. In a description of FIG. 8, a symbol “S” means a step.

In S801, the plurality of imaging/sound collection units 51 obtain a plurality of video signals and a plurality of acoustic signals. In S802, the time synchronization processing unit 13 adjusts the timings of the plurality of video signals and the plurality of acoustic signals on the time base, thereby obtaining the signals synchronized on the time base.

In S803, the three-dimensional model generation unit of the video signal processing unit 54 generates three-dimensional model data (three-dimensional shape data) of each subject at each time using the plurality of video signals having undergone the time synchronization processing and the imaging conditions. The three-dimensional model generation unit generates, for example, point cloud data or mesh data as the three-dimensional model data of each subject. The imaging conditions can include the position, the depression angle, the direction, the angle of view, and the focal length of each imaging/sound collection unit 51.

In S804, the position information calculation unit of the video signal processing unit 54 calculates locus data representing the time-series position information (three-dimensional coordinate information) of an arbitrary point (reference point) from the three-dimensional model data of each subject.

Next, in S805, the acoustic signal processing unit 55 separates the sound (sound source signal) generated by each subject from the plurality of acoustic signals having undergone the time synchronization processing by the sound source separation technique based on space data using the plurality of acoustic signals having undergone the time synchronization processing, the locus data representing the time-series position information (three-dimensional coordinate information) of the reference point of each subject, and the sound collection conditions, thereby generating the sound source signal of each subject. The sound collection conditions can include the position, the depression angle, the direction, and the directivity of each imaging/sound collection unit 51. Note that in a case where a plurality of subjects are obtained from the video signals, a sound is not always assigned to each of all the obtained subjects, a sound source signal is assigned to a subject that generates a sound, and no sound is assigned to a subject that generates no sound.

Finally, in S806, the free-listening point acoustic generation unit 16 generates a free-listening point acoustic signal using the sound source signal of each subject and the locus data of the three-dimensional coordinate information of the reference point of each subject. According to this embodiment, since it is possible to assign the sound source signal to the locus data representing the accurately obtained position information (three-dimensional coordinate information) of the reference point of the subject, it is possible to generate a more realistic free-listening point acoustic signal.

### Third Embodiment

### (Example of Configuration of Information Processing Apparatus 300)

Similar to the second embodiment, in the third embodiment, by using locus data representing the time-series position information (three-dimensional coordinate information) of the reference point of each of a plurality of subjects obtained from a plurality of video signals and a plurality of acoustic signals obtained by a plurality of imaging/sound collection units 51, a sound (sound source signal) generated by each subject is separated, thereby generating the sound source signal of each subject. This embodiment will describe a configuration in which more realistic free-listening point acoustic content can be generated by improving the sound quality of the sound source signal of each subject. Note that the configuration of a sound quality improvement processing unit 91 according to the third embodiment may be applied to the information processing apparatus 100 of the first embodiment.

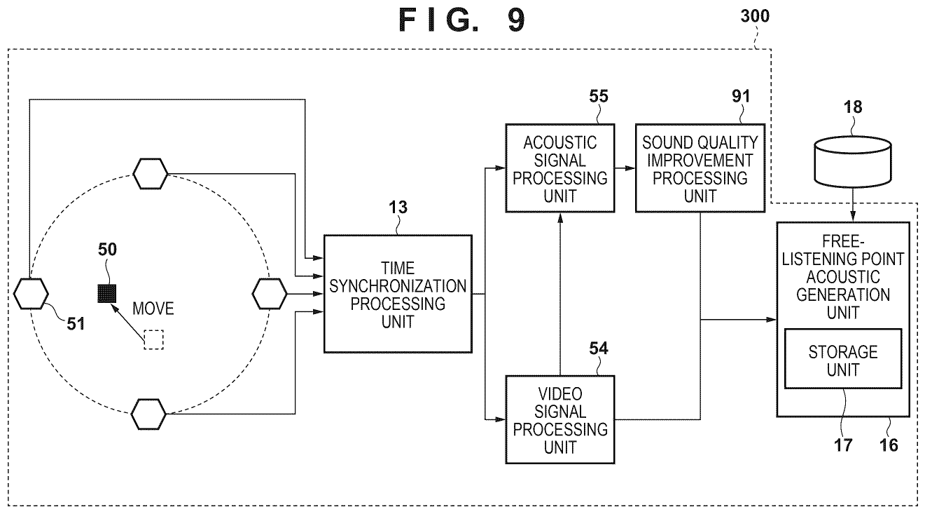

FIG. 9 is a schematic view showing an example of the configuration of the information processing apparatus 300 according to this embodiment. The information processing apparatus 300 includes the sound quality improvement processing unit 91. The remaining components of the information processing apparatus 300 are the same as those of the information processing apparatus 200 described in the second embodiment.

An acoustic signal processing unit 55 individually separates a sound generated by each subject from a plurality of acoustic signals by a sound source separation technique based on space data using a plurality of acoustic signals having undergone time synchronization processing, locus data representing the time-series position information (three-dimensional coordinate information) of the reference point of each subject generated by a video signal processing unit 54, and the sound collection conditions of each imaging/sound collection unit 51, thereby generating a sound source signal of each subject. The acoustic signal processing unit 55 inputs the obtained sound source signal of each subject to the sound quality improvement processing unit 91. Then, the sound quality improvement processing unit 91 further improves the sound quality of the sound source signal of each subject separated by the acoustic signal processing unit 55.

For example, based on differences in characteristics of the sound source signals of the subjects, in a case where the separated sound source signal of the subject includes a different sound source signal, the sound quality improvement processing unit 91 improves the sound quality of the separated sound source signal of the subject by reducing the sound source signal having a characteristic different from that of the sound source signal of the subject to be listened.

In a case where a free-listening point acoustic signal is generated using the sound source signal with improved sound quality, a free-listening point acoustic generation unit 16 assigns the acoustic signal with improved sound quality of the subject to the position of the locus data as the reference point, and generates an acoustic signal for listening, at a listening position, the acoustic signal with improved sound quality of the subject, which has been generated from the position of the locus data.

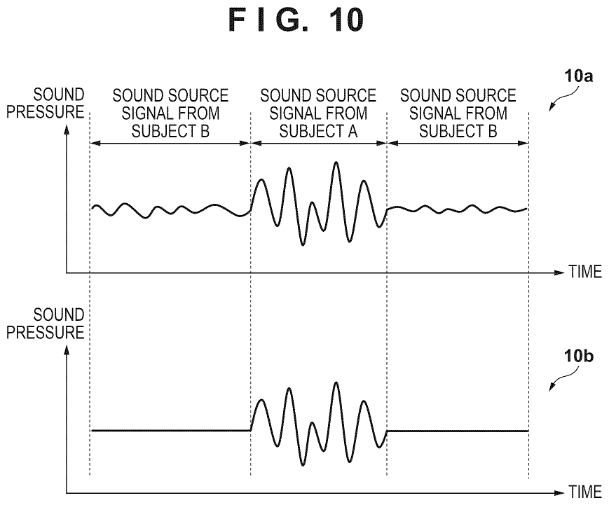

FIG. 10 shows timing charts showing an example of the effect of improvement of the sound quality of the sound source signal by the sound quality improvement processing unit 91. In FIG. 10, reference numeral 10a denotes a view exemplifying a low-quality sound source signal as a mixture of the sound source signals of the plurality of subjects. In FIG. 10, reference numeral 10b denotes a view exemplifying a high-quality sound source signal whose sound quality is improved by reducing the mixed sound source signal among the sound source signals of the plurality of subjects. The effect of the sound quality improvement processing unit 91 will be described below with reference to FIG. 10.

In a case where the number of imaging/sound collection units 51 arranged at positions surrounding at least a part of the periphery of the subject is small or a case where the distance between a plurality of subjects (for example, subjects A and B) that generate sounds is short, the sound source signal of the other close subject B may be mixed in the sound source signal of the subject A, as shown in reference numeral 10a in FIG. 10. In this embodiment, this signal is called a low-quality sound source signal of the subject.

The sound quality improvement processing unit 91 performs processing of improving the sound quality of the sound source signal of each subject separated by the acoustic signal processing unit 55. If the low-quality sound source signal of the subject is input as an input signal, the sound quality improvement processing unit 91 performs sound quality improvement processing of the low-quality sound source signal of the subject as a mixture of the sound source signals of the plurality of subjects. In the example shown in reference numeral 10a in FIG. 10, the sound source signal obtained by mixing the sound source signal of the other close subject B in the sound source signal of the subject A is input as the low-quality sound source signal to the sound quality improvement processing unit 91. As shown in reference numeral 10b in FIG. 10, the sound quality of the sound source signal of the subject A is improved by reducing the sound source signal of the other close subject B by the sound quality improvement processing of the sound quality improvement processing unit 91. In this embodiment, the sound source signal with improved sound quality of the subject is called the high-quality sound source signal of the subject.

In the example shown in FIG. 10, an example in which the sound source signal of another subject is mixed in the sound source signal of the subject, whose sound quality is to be improved, has been explained. However, if the sound source signal has low sound quality, a background sound (a sound whose incoming direction is uncertain) may be mixed, or sound quality may be distorted by sound source separation from the acoustic signal obtained by each imaging/sound collection unit 51. In this case as well, it is possible to apply sound quality improvement processing. In the example shown in FIG. 10, the example including the subjects A and B has been explained. However, the present disclosure is not limited to this, and the sound quality improvement processing can also be applied to the sound source signals of the plurality of subjects, the number of which is two or more.

A practical method of the sound quality improvement method by the sound quality improvement processing unit 91 will be described. The sound source signal of each subject (the low-quality sound source signal of each subject) separated and generated by the acoustic signal processing unit 55 is input to the sound quality improvement processing unit 91. Assume that the sound source signals of the subjects have undergone time synchronization processing by a time synchronization processing unit 13.

The sound quality improvement processing unit 91 separates, using these input signals, a sound (sound source signal) generated by each subject by the blind source separation method such as independent component analysis based on differences in characteristics of the sound source signals of the subjects in the three-dimensional space, thereby improving the signal to the high-quality sound source signal of each subject. An example of the blind source separation method has been explained but sound quality improvement processing may be performed by a neural network represented by deep learning. More specifically, an inference device that improves sound quality by causing a neural network to perform deep learning of a large amount of sound source signals of sound quality to be obtained and sound source signals whose sound quality is deteriorated by adding unnecessary sound source signals and the like may be used. Any method may be adopted as long as it is possible to improve the sound quality of the sound source signal of the subject.

According to this embodiment, since it is possible to assign the sound source signal with improved sound quality to the locus data representing the accurately obtained position information (three-dimensional coordinate information) of the reference point of the subject, it is possible to generate a more realistic free-listening point acoustic signal.

According to the embodiments of the present disclosure, it is possible to generate an acoustic signal for listening, at an arbitrary listening position in a space, a sound source signal generated from a sound source.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-091598, filed Jun. 5, 2024 which is hereby incorporated by reference herein in its entirety.

What is claimed is:

1. An information processing apparatus comprising:
a memory storing instructions, and
at least one processor configured to execute the instructions to:
perform time synchronization processing for a plurality of video signals obtained by capturing a subject by a plurality of cameras in a space and a plurality of acoustic signals collected by a plurality of microphones in the space;
calculate position information of the subject using the plurality of video signals and imaging conditions of the plurality of cameras;
separate a sound source signal of the subject from the plurality of acoustic signals having undergone the synchronous processing; and
generate an acoustic signal for listening, at an arbitrary listening position in the space, the sound source signal generated from the subject, by assigning the sound source signal of the subject to a position corresponding to the position information of the subject.

2. The apparatus according to claim 1, wherein the at least one processor is further configured to
generate three-dimensional model data of the subject based on the plurality of video signals, and
calculate three-dimensional coordinate information as the position information of the subject using the three-dimensional model data.

3. The apparatus according to claim 1, wherein the at least one processor is configured to separate the sound source signal of the subject from the plurality of acoustic signals based on differences in characteristics of sound source signals of subjects in the space.

4. The apparatus according to claim 1, wherein the at least one processor is configured to separate the sound source signal of the subject by adjusting a time delay to match phases of the plurality of acoustic signals in accordance with a distance obtained based on the position information of the subject and position information of the plurality of microphones.

5. The apparatus according to claim 1, wherein the at least one processor is configured to generate the acoustic signal by incorporating, in the sound source signal of the subject, a function representing a transfer characteristic of the sound source signal of the subject between the position information of the subject and the listening position.

6. The apparatus according to claim 5, wherein the at least one processor is configured to store the function obtained in advance in the space, and the function is interpolated based on a relative positional relationship between the position information of the subject and the listening position.

7. The apparatus according to claim 1, wherein the at least one processor is configured to calculate locus data representing time-series position information of the subject based on the plurality of video signals having undergone the synchronous processing and the imaging conditions of the plurality of cameras.

8. The apparatus according to claim 7, wherein the at least one processor is configured to separate the sound source signal of the subject from the plurality of acoustic signals using the locus data, the plurality of acoustic signals having undergone the synchronous processing, and sound collection conditions of the plurality of microphones.

9. The apparatus according to claim 8, wherein the at least one processor is configured to generate the acoustic signal for listening, at the listening position, the sound source signal generated from a position of the locus data, by assigning the sound source signal of the subject to the position of the locus data.

10. The apparatus according to claim 9, wherein the at least one processor is configured to generate the acoustic signal by incorporating, in the sound source signal of the subject, a function representing a transfer characteristic of the sound source signal of the subject between the position of the locus data and the listening position.

11. The apparatus according to claim 10, wherein the at least one processor is configured to interpolate the function based on a relative positional relationship between the position of the locus data and the listening position.

12. The apparatus according to claim 7, wherein the at least one processor is configured to improve sound quality of the sound source signal of the subject, and based on differences in characteristics of sound source signals of subjects, in a case where the separated sound source signal of the subject includes a different sound source signal, the sound quality of the separated sound source signal of the subject is improved by reducing a sound source signal having a characteristic different from a characteristic of the sound source signal of the subject to be listened.

13. The apparatus according to claim 12, wherein the at least one processor is configured to generate the acoustic signal for listening, at the listening position, the acoustic signal with the improved sound quality of the subject, which has been generated from a position of the locus data, by assigning the acoustic signal with the improved sound quality of the subject to the position of the locus data.

14. The apparatus according to claim 1, wherein the at least one processor is configured to determine a type of a reproduction apparatus by communicating with the reproduction apparatus configured to reproduce a sound based on a received signal, and change, in accordance with a result of the determination, a signal to be output.

15. The apparatus according to claim 14, wherein the at least one processor is configured to output the generated acoustic signal in a case where the reproduction apparatus can reproduce the sound at the listening position.

16. The apparatus according to claim 14, wherein the at least one processor is configured to output the calculated position information of the subject and the separated sound source signal of the subject in a case where the reproduction apparatus is an apparatus configured to reproduce the sound at a position different from the listening position.

17. The apparatus according to claim 1, wherein
the plurality of cameras and the plurality of microphones are arranged in the space to surround the subject, and
the plurality of cameras obtain the plurality of video signals by capturing the subject, and the plurality of microphones obtain the plurality of acoustic signals collected in the space.

18. An information processing method comprising:
performing time synchronization processing for a plurality of video signals obtained by capturing a subject by a plurality of cameras in a space and a plurality of acoustic signals collected by a plurality of microphones in the space;
calculating position information of the subject using the plurality of video signals and imaging conditions of the plurality of cameras;
separating a sound source signal of the subject from the plurality of acoustic signals having undergone the synchronous processing; and
generating an acoustic signal for listening, at an arbitrary listening position in the space, the sound source signal generated from the subject, by assigning the sound source signal of the subject to a position corresponding to the position information of the subject.

19. A non-transitory computer-readable storage medium storing a program for causing a computer to execute an information processing method, the method comprising:
performing time synchronization processing for a plurality of video signals obtained by capturing a subject by a plurality of cameras in a space and a plurality of acoustic signals collected by a plurality of microphones in the space;
calculating position information of the subject using the plurality of video signals and imaging conditions of the plurality of cameras;
separating a sound source signal of the subject from the plurality of acoustic signals having undergone the synchronous processing; and
generating an acoustic signal for listening, at an arbitrary listening position in the space, the sound source signal generated from the subject, by assigning the sound source signal of the subject to a position corresponding to the position information of the subject.
